(19) United States
(12) Patent Application Publication
(10) Pub. No.: US 2014/0316934 A1
(43) Pub. Date: Oct. 23, 2014

(54) COMPUTER-IMPLEMENTED METHOD AND SYSTEM TO MANAGE USER PROFILES REGARDING USER PREFERENCES TOWARDS A CONTENT

(71) Applicant: Telefonica, S.A., Madrid (ES)

(72) Inventors: Paulo Villegas Nuñez, Madrid (ES); Pedro Concejero Cerezo, Madrid (ES)

(73) Assignee: TELEFONICA, S.A., Madrid (ES)

(21) Appl. No.: 14/358,899

(22) PCT Filed: Nov. 7, 2012
(86) PCT No.: PCT/EP2012/072067

§ 371 Date: May 16, 2014

(30) Foreign Application Priority Data
Nov. 16, 2011 (ES) P201131844

(51) Int. Cl. G06Q 30/06

(52) U.S. Cl. CPC G06Q 30/0603; G06Q 30/0631
USPC 705/26.7

(57) ABSTRACT

A computer-implemented method and system to manage user profiles regarding user preferences towards a content.

In the computer-implemented method of the invention said content is previously rated by a group of users via computing devices, and it is characterised in that it comprises generating adaptive catalogues for a user by means of Item Response Theory models applied to said content and generating a user profile for said user by at least presenting items of said adaptive catalogues to said user, through a user computing device, and analysing scores given by said user to said items via said user computing device.

The system of the invention is arranged to implement the method of the invention.

### FIELD OF THE ART

The present invention generally relates, in a first aspect, to a computer-implemented method to manage user profiles regarding user preferences towards a content, said content being previously rated by a group of users via computing devices, and more particularly to a computer-implemented method that comprises generating adaptive catalogues for a user by means of Item Response Theory models applied to said content and generating a user profile for said user by at least presenting items of said adaptive catalogues to said user, through a user computing device, and analysing scores given by said user to said items via said user computing device.

A second aspect of the invention relates to a system arranged to implement the method of the first aspect.

### PRIOR STATE OF THE ART

Catalogues are a traditional commercial tool for many sectors. In past times, they were a key component of mail-order companies, allowing their customers to browse on the company stocks, features and prices. Catalogues are also important for museums and collections for visitors to know the stored pieces, and in large ones, to plan a route to visit the most relevant ones for a particular visitor.

As commercial companies stock and collections and in general all available information grew, the need to store it in information technology systems appeared, and databases and search engines replaced printed catalogues. These electronic systems provide extraordinary functionality for the user, moreover when they became accessible remotely, as it is generally the case nowadays in internet. However they require the user to introduce relevant keywords for the search to be really effective, and when the user is new to the system this can be troublesome. This effect has been called “the cold start” problem for many systems.

More recently, these systems have evolved to provide “recommendation” functionalities. With these, the system can recognize user interests and suggest items that are potentially interesting for a particular visitor, thus avoiding her or him to have to introduce and refine searches.

For all these purposes, a user profile is an essential component. User profile is a piece of information which stores information about user preferences, sociodemographic characteristics, and in general all required knowledge for the system to provide in an automatic fashion recommendation or guidance about the content store therein, and even the procedures to make a better usage of the system. The accuracy of the user preferences and knowledge has a direct impact on the effectiveness of the personalisation system. And another key property of this user profile is ease of creation. For instance, a user can be required to fill a long checklist of abstract concepts which do not reflect the practical knowledge of the user with respect to the content. As an example, many users would not be able to express preference for many art collection classifications if they do not know about them.

So there are two important properties for avoiding this cold start problem, and at the end, two challenges to make the process to obtain the user profile as effective as possible:
That the process to obtain the user profile uses concrete information, and representative of user mental model and organization.
That the process is easy to follow and of reasonable length.

Many personalisation systems acquire user preferences implicitly, i.e. from computations and inferences made on user interactions with the system. Many problems have been reported as inherent to this approach, as the “cold-start” problem, since they require a minimum number of interactions with the system. Even though these conditions are met, many reports show a trend to store only preferences for popular items, and more stereotypical users, thus been useful only for specific users and types of content. Moreover, users “seem neither to trust nor like a system that would silently learn preferences on their behalf” [1].

Many other systems use explicit processes for acquiring user preferences, usually in the form of a questionnaire or checklist that has to be filled when user first comes into the system. Traditional approaches to this process only offer abstract concepts to “tick” in a web checklist. But other approaches have appeared, based on presenting actual content that is associated to concepts. This is the case of some “tours” of a film catalogue stored in a movie recommendation system [3]. This way, the concept of guide to the actual content stored replaces the focus on the user having to introduce search terms or express opinion about generic, abstract, concepts.

However this approach has also the risk of confusion, in particular if the association concrete content items and abstract concepts, that are what is stored at the end, are not explicit or well proven.

For instance a new user of a movie recommendations system can rate very highly Hitchcock's “The birds” without knowing that this movie is internally assigned to the system's category “terror”. If the user is not offered any other film in this category for rating, storing a high preference score for “terror” can be an important error.

These errors are mainly based on two facts:
Content items may be editorially associated to keywords or concepts without user participation. Even if the association is tested in some particular way, there will always exist the possibility of confusion for a particular user, because subjective appreciation of content and concepts is quintessentially variable between users.
Content groups or categories (which can be called catalogues or collections of “items” for the preference profiling purposes) are often closed sets, i.e., they are composed of a number of items that are considered indistinguishable by users (in the sense of their belonging to the group). Even if the presentation order is changed, the profiling method assumes that all items in the set are presented to, and rated equally by, the user.

Psychological methods for measurement of preferences and attitudes exist from the very beginning of Psychology as a science. An early example is the “Law of Comparative Judgment” theory devised by Thurstone in 1927, which produced the methodology of pairwise comparisons, successfully used for long to measure perceived intensity of physical stimuli, attitudes, preferences, choices, and values. More recently, Bradley-Terry-Luce created the BTL model (Luce, Individual Choice Behavior, 1959 and 1977 [11]), which allows preference measurement from pairwise comparisons.

Modern psychometrics are based on models that have evolved from these early approaches, and are known as Item response theory (IRT). Item Response Theory models [10] are standard in educational and attitudinal tests, and are based on the mathematical relationship between the response to a particular “item” (e.g., a question in a spational reasoning test) and a level of an internal trait of the person (spatial reasoning ability). That is why they were also called “latent trait models”. An important theoretical and practical advantage is that they allow for the simultaneous scaling of both subjects (test respondents) and the latent trait in the same measurement scale. The latent trait can be any aspect or construct of human behaviour in which individual differences are to be measured, as academic performance, personality constructs, attitudes, and, of course, interests. This is usually referred to as θ (theta).

A basic model for measurement of spatial ability mentioned above is a logistic two-parameter model, or Rasch's model [15], as

$${p}_{i} ( θ ) = \frac{1}{1 + {e}^{- {Da}_{i} ( {θ}_{a} - {b}_{i} )}}$$

where aᵢ is the discrimination parameter of the item, bᵢ is the difficulty of the item, and D is a constant as a scaling factor to approximate the probabilities to those of a normal distribution [15].

This model allows for a full description of an item with respect to the latent trait in what is called “Item Characteristic Curve”, or ICC, which has a familiar S-shape, whose slope, or change rate, is defined by bᵢ. Theoretically the difficulty parameter describes where the item is located in the scale of the latent trait, or also the position of the item in the measurement scale of the latent trait. This model is only appropriate for yes/no (or success/failure) responses. For preference measurement, this model would be only applicable to “yes, I like”, “no, I don't like” responses.

Many models have been proposed as generalizations of the basic logistic model for other types of user responses which are also usual in many contexts, as rating scales (i.e., a graded response in an explicit numeric scale, 1 to 5 for instance).

The PCM, or Partial Credit Model (Masters, 1982) [12] is the simplest of all IRT models for ordered categories. It contains only two sets of parameters: one for persons and one for items. All parameters in the model are locations on an underlying variable. PCM can be considered as an extension of other Rasch's models for dichotomies, by extending the model to pairs of adjacent categories in a sequence. The simplicity of the model formulation makes it easy to implement in practice.

PCM model can be expressed as:

$$\frac{{P}_{ij 1}}{{P}_{ij 0} + {P}_{ij 1}} = \frac{exp ( {θ}_{k} - {δ}_{i} )}{1 + exp ( {θ}_{k} - {δ}_{i} )}$$

In the case of ordered responses beyond the 1-0 case, it follows from the intended order 0<1<2 . . . <m(i) of a set of categories that the conditional probability of scoring x rather than x−1 on an item should increase monotonically throughout the ability range. Therefore the expectation of the probability of a person responding x on item i versus responding a lower rating or category is a function of the latent variable theta(k) and the “difficulty” of responding that particular category for that particular item.

IRT models allow the development of subject-adaptive tests and computer-assisted testing (CAT) [18]. A key practical advantage of this approach to psychological testing is the variable length and the adaptive nature of the tests. This is so because of the mathematical properties of the computed IRT model parameters, as confidence intervals for all parameter estimates, and more importantly, for the respondent's latent ability, which allows for rules to stop a measurement process because the measurement will not improve or will not vary further than specified by said confidence interval.

Some existing user profile capture processes are summarized below, and the advantages of using a different approach, as the one presented here, are discussed:
Acquisition of preferences via a hierarchy of concepts

In this approach, user preferences are described by means of an organized list of categories. The category list or tree is usually pre-defined, for instance after a user study, or by relying on experts on the field. However, a reported problem of this approach is the likelihood of mismatch between content preferences and preferences for content categories [8].

Reported problems about this approach are:

1. User Interface issues: if the designed list of categories is comprehensive, the process is tedious because of the fixed length of the questionnaire, and while a compromise can be made, if the length of the categories is drastically reduced there is a high risk of limiting the measurement to most popular categories.

2. Understanding categories: this approach relies on the assumption that the content classification reflects the user's mental representation of the actual content. Usually the taxonomies or ontologies are designed without taking into account the end-user point of view [16] and may cause confusion in a potential user and hinder his or her ability to express preference for them.

As a conclusion, this approach can produce expansive hierarchies that are long, difficult to understand and in some cases, not relevant for the task of expressing preferences.
Acquisition of preferences via a list of content items

This approach consists of the system providing the user content for her or him to choose or rate, and by means of these responses the system can infer her or his user preferences. For instance, the responses can be matched to a pre-defined stereotype, which is then stored as the user profile.

This approach usually makes the process simpler for the user. For example, in PTVplus [17], preliminary profile information is collected from the user at registration time to bootstrap the personalisation process (the user can rate content from the program guide positively or negatively). But in such a system, the user does not know how much content she or he has to evaluate (i.e. when the acquisition phase terminates), and it appears that in practice, when a list of content is presented to users, they tend to rate mainly content they like, while ignoring content they dislike instead of rating it negatively.

Another example is that of the technology provider Choicestream [2], which proposes the new user a short ‘jumpstart’ questionnaire, containing well-designed questions. The more similar the user preferences to those of previously defined groups, the higher the score of similarity towards those groups. The system is designed to iteratively learn about user cohorts preferences. However all the advantages of this approach, it is clearly based on segmentation mechanisms, i.e., homogeneous group measures, and not on differential individual measures.

Another example application is provided by Movielens (Grouplens Research Group [6]). With this system you can ask the user to select or rate which themes he is interested in. The user is assumed to know a relevant subset of the themes. One problem is that, most often, the categories are non-mutually exclusive: adventure, action, comedy, drama, romance. However, this is essential information to be contained in any user profile in this area, since it will be one of the most distinctive features for any user.

Alternatively you can ask the user to rate actual items. For instance, MovieLens requires a minimum of 15 ratings for films to start providing recommendations to a new, just subscribed, user.

There are also problems from this approach, especially the relationship between the ratings of movies and the inferred preference about the genre of the film. For instance a new user of a movie recommendations system can rate very highly Hitchcock's “The birds” without knowing that this movie is highly related with the category “terror”, and if no other terror film is rated, his rating for that category in the automatically generated profile can result very high. Only by a close and regular review of the profile can the user notice and correct these errors.

This is a real example which happened when filling the “controversial films” tour proposed by Filmaffinity [3] as the initial step for creating a user profile in this website. This website offers no less than 34 tours, therefore it would be a really lengthy task for a user to rate all the sets contained therein. Generally speaking, users almost always consider entering preferences as a tedious task (Jameson, 2004 [9]), which they often skip; this usually results in bad recommendations at the initial moments of the interaction.

There are many other patents on content preference profiling. Some of them are summarized next:
Viljamaa and Anttila (2007) patent “Network-based determination of user content preferences” relates particularly to tailoring content to conform to group preferences. Their scope is about searching for content, i.e., users query content databases, such as media for personal enjoyment (e.g., music, literature, movies, art, etc.) that is selected based on a user's personal tastes.

Their proposed invention proposes a method for determining preferences of a plurality of users via respective processing devices of the users, via a network entity, and in such a fashion that the preferences are merged to form a group preference associated with the plurality of users. Content is provided to at least one of the users using the group preferences.

Therefore in this case, the preferences are not individual constructs, rather they are representative of groups of users.

Apart from this, nowhere in this patent the measurement model and techniques for capturing the preferences is described. Rather, generic methods for storing and managing the user preferences are described.
Kim, Lee and Han (2009) patent “User preference-based data adaptation service system and method” is more focused on finding out nodes that are similar in the preferences than in the preference measurement method itself.
Chapelle and Selvaraj (2011) patent on “Efficient Algorithm for Pairwise preference learning” proposes an interesting mechanism for preference learning, or measurement, based on pairwise comparisons of content items. Their system and method is based on fixed-length, and non-adaptive, item sets or catalogues.
Willis (2008) patent on “Interface for collecting user preferences” focuses on the user interface components for this purpose, without describing the mechanisms and models behind the preference measurement.

### DESCRIPTION OF THE INVENTION

It is necessary to offer an alternative to the state of the art which covers the gaps found therein, particularly related to the lack of proposals which really improves the acquisition of preferences via a list of content items in order to obtain in a faster and more reliable way a user profile indicating his preferences.

To that end, the present invention provides, in a first aspect a computer-implemented method to manage user profiles regarding user preferences towards a content, said content being previously rated by a group of users via computing devices.

On contrary to the known proposals, the method of the invention, in a characteristic manner it further comprises generating adaptive catalogues for a user by means of Item Response Theory models applied to at least part of said content and generating a user profile for said user by at least presenting items of said adaptive catalogues to said user, through a user computing device, and analysing scores given by said user to said items via said user computing device.

Other embodiments of the method of the first aspect of the invention are described according to appended claims 2 to 19, and in a subsequent section related to the detailed description of several embodiments.

A second aspect of the present invention concerns to a system to manage user profiles regarding user preferences towards a content, said content being previously rated by a group of users via computing devices.

In the system of the second aspect of the invention, on contrary to the known systems mentioned in the prior state of the art section, and in a characteristic manner it comprises:
a first server which at least stores items and ratings associated thereto from said content, and computes at least part of said items and ratings;
an Item Characteristic Repository which stores said items and ratings in the form of item banks; and
a session management module which creates adaptive catalogues with items from said Characteristic Repository and computes scores given to said items of said adaptive catalogues by a user connected to said session management module via a user computing device in order to provide a user profile for said user.

Other embodiments of the system of the second aspect of the invention are described according to appended claims 21 to 24, and in a subsequent section related to the detailed description of several embodiments.

### BRIEF DESCRIPTION OF THE DRAWINGS

The previous and other advantages and features will be more fully understood from the following detailed description of embodiments, with reference to the attached drawings which must be considered in an illustrative and non-limiting manner, in which:

FIG. 1 shows a high level description of the Adaptive Catalogues Profiling System, according to an embodiment of the present invention.

FIG. 2 shows the Adaptive Profiling System processes and flows of information, according to an embodiment of the present invention.

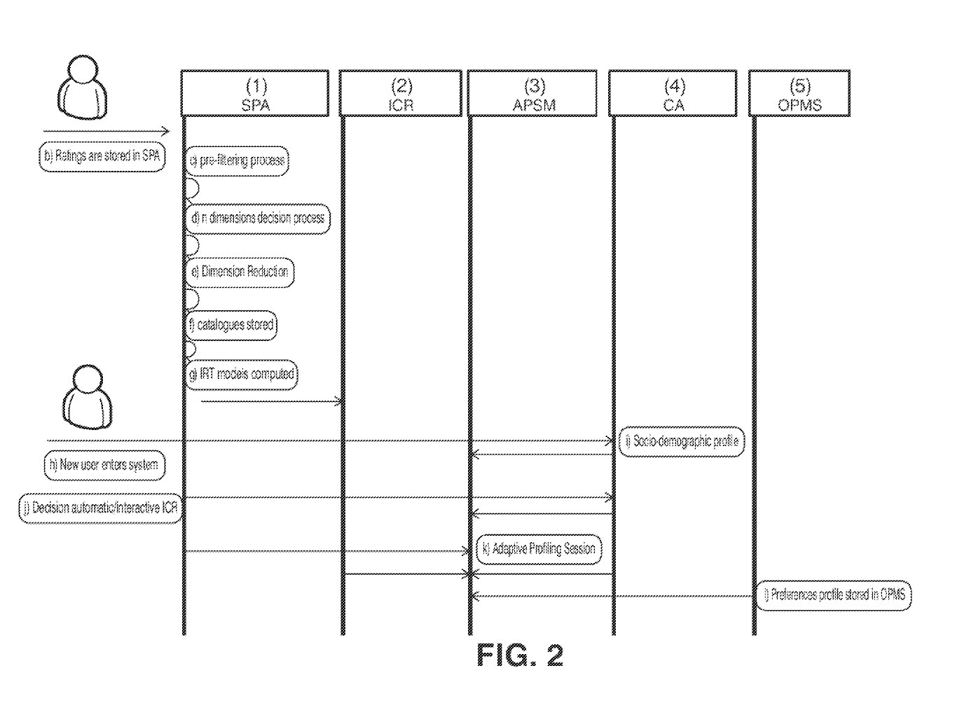

FIG. 3 shows Item Characteristic Curves for movie 1200, according to an example embodiment of the present invention, wherein it can be observed that the item location parameter is very close to scale centre.

FIG. 4 shows Item Characteristic Curves for movie 1587, according to an example embodiment of the present invention, wherein it can be observed that the item location parameter is skewed to the right so that this movie is more representative of a movie particularly well rated by those individuals having higher values of the preference towards this catalogue.

FIG. 5 shows Item Characteristic Curves for movie 1261, according to an example embodiment of the present invention, wherein it can be observed that this item shows a strange pattern, with the thresholds between ratings much compressed, making this movie not a good candidate to start the scoring.

FIG. 6 shows Item Characteristic Curves for movie 2985, according to an example embodiment of the present invention, wherein it can be observed that this item presents a good span across the different rating responses.

FIG. 7 shows an item map which deploys all items for catalogue 8, together with the distribution of preference measurements, according to an example embodiment of the present invention.

### DETAILED DESCRIPTION OF SEVERAL EMBODIMENTS

This invention proposes a method and a system which is capable of creating, storing and managing user profiles regarding user preferences towards any kind of content or objects (including, but not limited to, music, movies, literature, and consumer goods). The new modules of this user profiling system which are an essential part of the invention are:
A method and system to automatically generate and store in a computationally tractable form content or item catalogues, i.e., generated from ratings or decisions made by users in the past, and with no manual intervention from operators or judges. This can be considered an off-line user-profiling system.
The method and system to generate and manage the adaptive process by which a new user interacts with the profiling system, receiving and responding the catalogues, following an individual process from each single response. This is the on-line user profile management system. Due to the mathematical properties of the models which generate such catalogues, the catalogues are adaptive, i.e., are presented in individually customized subsets following an adaptive sequence. Therefore, they do not need to be presented in full to obtain a reliable and valid measure of the preference for the catalogue

A standard starting point is a database of item ratings obtained from existing users of the system or from historic transactions with the stored content. But different from all previously defined systems, these ratings are mathematically treated so that they can be grouped in dimensions that are as independent of each other as possible, by using dimension reduction techniques, such as Factor Analysis, Principal Components Analysis, Multidimensional Scaling or any other mechanism with similar purpose.

The newly devised dimensions represent a latent construct which is the preference to similarly rated pieces of content, which are called “Item Banks”, or also, “Catalogues”. These catalogues will be the basis for the generation of processes from which preference scores towards those dimensions will be computed. Each score will measure the preference for a particular latent construct representing each dimension. The set of scores will form the User Preference Profile.

For this purpose, the proposed method and system is based on Item Response Theory models computed independently for each dimension or catalogue. These catalogues are fully characterized by the model parameters, thus allowing ranking and classifying the items (the catalogue components) for its use in an adaptive presentation mechanism, called Adaptive Profiling Process (APP). By means of this mechanism, elements of each catalogue are presented to the user in an iterative and personalized fashion, i.e., after a starting item pre-defined in each catalogue, the subsequent items presented depend on the running score computed for that individual by applying the models. Together with the score, a confidence level is also computed, which allows for setting a condition for signalling when the procedure has achieved a reliable score.

This score is interpreted as the preference measurement for a particular dimension, and will be one essential part of the final User Preferences Profile (UPP).

Adaptive catalogues are presented one by one, either in a fully automatic fashion, or by interactive inputs by the user, until the UPP is completed. At the same time, ratings and user inputs are stored back in the Item Repository.

The proposed system is composed of the following elements:
A Server for Preference Analysis (SPA) that takes in a dataset collected from the activity of a plurality of users in a certain online or offline service, fed to the system via a continuous network connection or a batch uploading procedure. The data takes usually the form of a repository of items, together with the recorded preference of the user for those items. These may be explicit, giving a rate on a certain scale, providing e.g. a dichotomous response (“like”, “don't like”) or implicit, providing an event such as “purchased”. The service can collect also other types of interaction and associated user information.

The SPA is composed by a set of modules which work automatically and off-line (with the obvious exception of the input from user information and the output to other systems working in parallel). The SPA processes the data and extracts as output of a set of steps mentioned below the so-called Item Characteristics Repository (ICR).
The ICR itself, formed by a database holding collections of Item Characteristics in a suitable form for efficient retrieval.
The Server for Adaptive Profiling Session Management (APSM), capable of creating user-adapted profiling sessions in which items are chosen and presented to the user for preference elicitation in a sequence uniquely determined for each user and session.
A client application CA, through which the items selected and sent by the APSM server are shown to the user, and the users feedback is gathered and sent back to the APSM for continuation of the session. The application can run in either a mobile device or a desktop system.
A final Online Profile Management System (OPMS), which stores the output of the session with the user, in the form of quantification of user preferences in a series of latent dimensions spanned by the items. The output of the OPMS can feed a service that takes use of the profiling information generated, such as a Recommendation Engine or a Personalization Server (such additional systems, though, are out of the scope for this application)

In an alternative configuration, blocks 3 and 4 and, to some extent, blocks 2 and 5, can be combined into a single client-side autonomous application (CAA). This application is then made downloadable and installable in a user device (typically a mobile device); inside it will contain a selected portion of the ICR, reduced to make it manageable as a downloadable application (the ICR subset can be uniform, for all users or can be tailored on the fly to the user downloading the application, based on a demographic profile explicitly provided by the user or implicitly deduced by the system from the context of the download request, e.g. by IP geocoding).

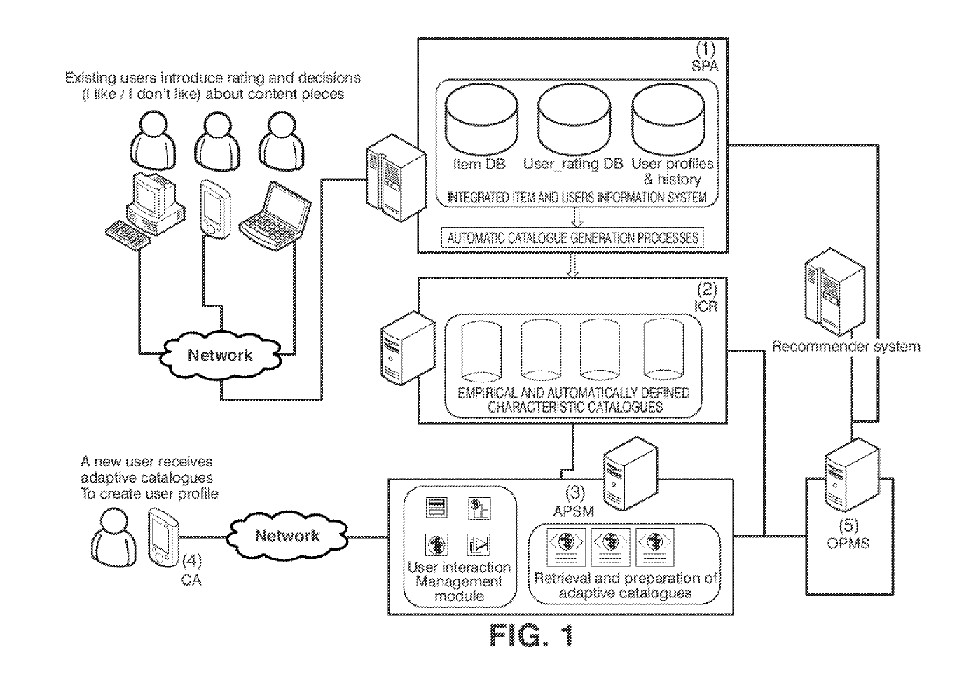

FIG. 1 illustrated these system components. The described system works by carrying out the following steps:

a) Existing users provide ratings on pieces of content by using their usual systems, i.e. personal computer, tablet, laptop, or smartphone.

b) These ratings are stored in the SPA, together with the databases containing features, labels, classification data and, in general, all required item information that should be available in subsequent steps of the process.

c) The SPA executes a pre-filtering process, by which individuals and items are selected from the item repository according to specific criteria, producing a reduced ratings matrix individual x item, which will be a subset of the repository defined in step 1.

d) Then it runs a process to decide the number of dimensions n in which the items contained in the item repository will be classified, by means of Dimension Reduction techniques, such as, but not limited to, Factor Analysis, Principal Component Analysis, Cluster Analysis, Multidimensional Scaling and other related ones. This number of dimensions is an important output since it will determine the number of Item Banks defined afterwards. The process is frequently iterative, with a number of tries of steps (d) and (e) executed until a satisfactory result is obtained, but it could also be executed as a single forward process.

e) When n is decided, the SPA applies the Dimension Reduction technique on the individuals x item rating data collected in (a), with the request to extract the n factors or dimensions defined previously. Output of this step will be an organization of all items into catalogues, each one as internally homogeneous as possible, and at the same time as un-correlated as possible with other catalogues. Therefore the system will classify all available content automatically, based on all available user opinions and ratings, and not requiring any expert judge input about this classification (for instance, deciding the best genre description for a movie). Though of course a manual inspection of the catalogues will be possible, it is not a requirement, thus obtaining a fully automatic process to periodically classify all available content in the system.

f) Once the classification items-dimensions is defined, item ratings-banks (catalogues) will be prepared, one per dimension, containing the available ratings for each dimension and their corresponding items.

g) A system module computes IRT models for each of the dimensions. This is the final result of the SPA. Output of this procedure is an Item Characteristic Repository (ICR), containing all computed model parameters, and which will allow for rank ordering items according to parameters like difficulty or discriminability.

h) A new user enters into the system to get her/his profile, or UPP, computed. This is done via the client application CA (4) connecting to the APSM Server (3)

i) A socio-demographic profile of the user entering into the system is collected via the CA. This socio-demographic profile can be obtained previously to using the system (i.e., the user is already a customer, and his data are stored in the company systems), or can be requested by traditional means, i.e. a form.

j) In an intermediate step the user can decide whether the ICR selection process is automatic or interactive. By means of the former, the system will automatically select the item bank to be presented for rating or decision to the user, based on available information like the model parameters or previous knowledge, or strategic decisions (i.e. presenting the most popular items first). By means of the later, the user will be able to choose which item bank will start the process, and each subsequent one.

k) An Adaptive Profiling Session (APS) takes now place, which is the process in which the user profile is determined by choosing, for each dimension, the optimal items from among the ones available in the ICR and presenting them to the user.

l) The computed preference profile is stored in the OPMS Service (5). This UPP repository contains all preference measurements for all the users in the system, for the different dimensions.

The next subsections describe with some additional details those steps, relating them to the method and system proposed.

Item Repository (a,b)

The starting point is the availability of a repository of elements (“items”) subjected to evaluation by users. This evaluation can have different shapes, but in general the outcome is a rating value for the item, made by each user. Expressions of preference can use different scales, such as binary (“like”/“not like”), integer (e.g. 1-5 rating value), or continuous. The final result is a user x item matrix, in which columns express items, rows express users, and each cell contains the rating given by the corresponding user to the corresponding item.

Not all items need to be rated by all users, and in general the opposite will be the case: the user x item matrix will contain many holes (equivalent to “don't know”), since commonly users only rate a small subset of all available items.

Repository Pre-Filtering (c)

Given that the original user x item repository is not a dense matrix, for consistency and reliability of the process we proceed to filter it, retaining only a subset of cells that is deemed as most adequate for factor analysis.

The best subset is that one in which we maximize the probability that any two given items have common users giving ratings to them, thereby improving the stability of the correlation between items. A number of different strategies can be followed to achieve that aim, such as:
Create a subset by collecting the items columns that contain the highest possible number of ratings, for instance by applying a minimum threshold to the rating count. This would be akin to selecting the “most popular” itemset.
Create a subset by choosing the items whose rating distribution is as expanded as possible (i.e. maximum variability), subject also to some threshold on the minimum amount of ratings (to eliminate noisy items). This would be akin to selecting the “most controversial” itemset.

The final result is still user x item ratings matrix, albeit with reduced dimensions with respect to the one in step 1 and with lower sparsity characteristics.

Dimension Determination (d)

In general, the optimal number of dimensions in the factor analysis will be highly dependent on the problem domain and, to a certain extent, on the dataset used: though a large enough dataset should show stability in terms of adding or removing rows/columns, the specifics of dataset generation (i.e. rating scale, collected user sample, etc) do have significant influence on the results.

For this reason there is no universal procedure for setting the number of dimensions. A number of heuristics can be applied to the concrete dataset used, in an iterative procedure that applies the factor decomposition in step 4 with an increasing number of dimensions, and then compares some statistics on the resulting decomposition to find the optimal point. Typically analysis of the eigenvalues produced in the factor decomposition is done to resolve this decision.

Dimension Reduction (e)

Once the number of dimensions is set, dimensionality reduction to that number of dimensions is applied to the user x items matrix, following procedures such as PCA (Principal Component Analysis), Factor Analysis or any of the recent advances of these techniques such as the BIFACTOR model (Gibbons and Hedeker, 1992 [4]). The outcome is, in any case, a set of weights for each item that reflect the degree of assignment of that item to each of the dimensions.

Factorization of a user-item matrix is a standard procedure in recommendation engines, in which it is customarily used to extract a reduced set of dimensions that help to better characterize the items and ease computation of item similarity. However in the present invention it is used a non-standard variant of dimension reduction by applying the special requirement of forcing each item to be projected to only one significant dimension. This stems from a requirement of the IRT technique, in which items need to be one-dimensional (i.e. they will express preference for only one of the dimensions). The exact procedure for achieving this requirement can vary: it can be incorporated into the dimension reduction process itself, or applied as an afterstep, for instance, by using some thresholding on the set of weights, so that only the items with enough one-dimensional values (i.e. only one weight is significant) are retained on the dimensions of interest.

Item Rating-Banks (f)

In this step the retained items after factor analysis are stored in item banks, which take the form of a database at the server side. There is one item bank per dimension, and each bank contains the items assigned to that dimension together with their ratings.

Creation of the Item Characteristics Repository (g)

Each item bank goes now into the IRT model determination. This iterates across all items in the bank. For each item, its ratings are used to adjust the IRT model and extract the parameters of the IRT model that provide the best fit to the rating data.

The outcome (parameterized IRT models for each item) is stored in an Item Characteristics Repository. This database contains the whole set of items, clustered by dimension, and for each item the parameters of its IRT model. This will be the source for the creation of the adaptive profiling tool.

The application of IRT models proposed in the present invention differs from its standard usage in CAT generation, which is mostly oriented towards aptitude or educational testing (and not for preference selection). In this standard usage, test items are questions or problems presented for a user, and the success or failure, or a degree of each, is computed from the user response. After computation of the IRT models, parameters of that model for each question can be used to give a measure of the item difficulty related to the latent dimension being evaluated.

In the present invention the elements in the ICR are not questions, but bare items, for which it is requested from the user a direct evaluation of preference in a given scale. The corresponding model parameter for the item is then interpreted not as difficulty, but as a measure of the “dislikeability” of the item in the latent dimension. That is, it is used to characterize the degree of assignment of the item within the preference dimension spanned by the factor being studied, and as such it is employed in the Adaptive Profiling Process described next.

User Profile Initialization (h,i)

The system contains a database for user profile information. A start-up profile is generated for all new users entering the system. This start-up profile contains basic information about the user, as needed to enable the user to log into the system, as well as minimal demographic data about the user (age, gender, precedence, occupation or study level). This initial data can be obtained from the user by an online questionnaire submitted when the user registers into the system via a desktop or mobile terminal, or can be already available at the server side thanks to access to a customer database (if the user is already a customer of the service).

Most data fields are optional, to avoid an increased abandon rate for registering users, so that it is possible that no valid demographic information is included in the initial profile. Therefore the system is designed to work also in the absence of demographic data; when present, it is used to better characterize that user in order to select the most appropriate items from the ICR for profile learning in the adaptive profiling process phase. To that aim, the rank ordering of items in ICR performed in step 9 will be computed only over the user base with a matching demographic profile to that of the user (the demographic data is relaxed to the required degree to achieve a large enough user base).

Ordering of Dimensions for Adaptive Profiling (j)

In general it is required that the user supply item answers for all dimensions determined in the factorial analysis, otherwise the profile would be incomplete (though it might be possible to truncate the set of dimensions if needed). For that reason the profiling phase needs to supply item banks for each of the itemset dimensions. This can be done either automatically or interactively:

1. If done interactively, the system shows the user the set of available dimensions, instantiated via a set of candidate examples or, in the case in which the obtained dimensions have been characterized semantically, via their assigned semantic labels. The user can then choose the order in which he fills in the form for each dimension.

2. If done automatically, the user is shown the forms in an order automatically defined by the system. A number of procedures can be used to determine the optimal order, with the double aim of trying to achieve the most complete and most accurate profile possible:
If aiming at completeness, for instance, in case the dimensions are not exhausted (because the user exits the procedure before finishing), usefulness of the profile is maximized. A procedure in this case will be ordering dimensions by decreasing item population, so that more populated dimensions are answered first, and hence the chance that the user preference for any arbitrary item can be characterized is maximized.
If aiming at accuracy, dimensions should be ordered so that the ones whose expected duration (in term of number of items needed to achieve the stop criterion) is lowest come first. This would allow achieving, at each completion step within the profile acquisition phase, the greatest number of dimensions covered with the minimum possible set of items. Again, this ensures that on premature exit as many dimensions as possible have been covered.

Adaptive Profiling Process (k)

As mentioned, the APP is the process in which the user profile is determined. This is done by choosing, for each dimension, the optimal items from among the ones available in the ICR and presenting them to the user in order to rate them.

Within any dimension, the process is iterative, at each iteration the following actions are performed:

1. Selection of the next item for the user to rate/decide on them, from among the ones contained in the ICR for that dimension. This is done according to a criterion for choosing the optimal item in terms of discrimination power for the user preference in that dimension.

2. Computing the UPP score (user preference measurement for the construct represented by that dimension) using the models computed in 6. Together with the estimate of this latent construct in each step or response to a particular item, a confidence interval will be computed which is input to subsequent step in this part of the process.

3. A stop rule, which tells the system that the computed UPP score for a particular dimension is within the confidence interval, i.e., the score will not significantly deviate from the last estimate even if no more items are presented (again, for a particular dimension).

4. A procedure to store back all produced ratings to the Item Repository defined in 1, so that the Item Repository is enlarged and updated with the information produced by the user.

The criterion for selection of the next item to rate is based on the parameters extracted on the IRT model for each item. The objective is to select the item whose decision by the user gives the most information on the users preferences for this dimension.

There are a number of possible variations in the selection, depending on which IRT model has been chosen, and which parameter(s) in the IRT model are chosen for rank ordering. For instance, if the item difficulty D is taken in consideration, the procedure will start by selecting the item whose value of D is most discriminative across the dimension; in practical terms this means the initial item whose prior probability of decision is at about 50% from among the subset of users having shown a preference for this dimension.

Depending on the decision by the user on this first item, the next item is chosen so as to further reduce the error margin in determining the user preference. For instance, if the user rates the presented item with an acceptance value (i.e., a rating that can be considered as a “like” decision, this will depend on the scale used), the next item shown will be one whose prior probability of acceptance is above 50%; if it rates with a rejection value, an item with prior probability below 50% will be presented. Iteration is continued until the stop criterion is met.

### Embodiment of the Invention

This example embodiment uses MovieLens movie ratings databases, as they are well known in the user profiling and in recommendation contexts, and have enough size as to be significant for an embodiment of the method and system. MovieLens (http://www.movielens.org) is an online movie recommender system that invites users to rate movies and in return makes personalized recommendations and predictions for movies the user has not already rated. It is run by a research group in the Department of Computer Science and Engineering at the University of Minnesota. It is one of the most popular non-commercial movie recommender sites. Movielens users can rate movies on a 0.5- to 5-star scale, in 0.5 steps. MovieLens encourages users to rate movies they have seen, and offers to the outside community some datasets containing sections of their user-ratings database

1. Creation of the Integrated Item and Users Information System (a,b)

The SPA deployment is launched by loading onto a relational database the different user and movies information tables contained in the Movielens dataset chosen, in order to make available all these data to the other subsystems. Tables in this database contain film titles, year of production, genre, director, and of course, raters—individuals providing the rating—with arbitrary codes, ratings and a timestamp for the rating.

2. Automatic Catalogue Generation and Storage System

2.1 Pre-Defined Content Filtering (c)

For the purpose of the profiling system, and in order to have an efficient storage of catalogues, a selection of the most relevant pieces of content is required. The following examples consider several possibilities tested with the MovieLens database as a representative example of this kind of databases.
One approach, as previously mentioned, is selecting the content (movies) with more ratings. The resulting dataset will be called the “most popular” one, since it often happens that more popular items receive higher number of ratings, while new or less popular items receive lower numbers. In the example, if a cutpoint at 10000 ratings is established, it gives as a result a subset of the 174 “most popular” movies in the MovieLens dataset. However, it is a well-known fact that many users only rate those items that they like, while for those they do not like they simply ignore them, and prefer not to rate. Therefore, it is possible that the most popular ones are actually the “best” ones, so any average user would like too many of the items in this dataset.
On the other hand, a user's profile is made more accurate when the user's rating: (a) differentiates the user's taste from other tastes consistent with his prior ratings, and (b) associates the user with a different set of similar users. This improved accuracy is greatest when the movie being rated has a high variance in ratings (i.e., many people like it, and many dislike it), and when that movie also has been rated by many others.

Therefore an alternative approach is proposed, once known some basic facts about the variability of ratings, by selecting those movies with variability larger than a cutpoint. By selecting those films with average rating below 4, standard deviation larger than 0.95, and 5000 ratings as a minimum, it gives as a result a subset of 175 movies (some of them are also part of the “most popular” dataset). This subset may have the advantage of better distinguishing between different “profiles” of users. This set will be called the most “variable” (not strictly so, as a fairly large number of ratings per movie is still kept, but it is at least “more” variable than the most popular one).

Therefore the system will in this case implement for the automatic computation process, the “most variable” (or controversial) set of movies.

The system will use SQL scripts that will automatically produce two matrices of individuals * ratings (items), according to the two approaches explained above. This is the input to the procedure to compute the correlation matrix between items. The algorithm chosen is such that the correlation of each pair of variables is computed from the cases for which both variables are present, using the usual formula for correlation. A minimum number of ratings per user is set, or alternatively a maximum number of missings to perform the calculation of correlation.

For this application the maximum number of missing values, or MMV, was set to 170. This setting eliminates 5631 cases (or raters) out of the 68578 available in this database, with a remaining number of cases of 62947. As it can be imagined, this dataset has a fewer pairwise number of ratings than the most popular alternative. Maximum number of movie ratings (pairwise) is 25677 and minimum is 4988. It is possible to conclude that, save one case, the correlation matrix for this alternative was computed with at least 5000 ratings per combination of movies. Harmonic mean of sample sizes used for computing this correlation matrix is 7899.

2.2. Processes to Determine the Optimum Number of Catalogues (d)

It is well known that dimension reduction techniques require the previous specification of the number of dimensions (in this case, catalogues) to be extracted, and they do not provide any clue of an optimal number of factors. One of the techniques to find out an optimum number of dimensions (i.e., an optimum number of relevant catalogues) is parallel analysis (Horn, 1965 [7], O'Connor, 2000 [13]). One example implementation is in the R library nFactors (Raiche and Magis, 2010 [14]).

In this example, this process produces as an output f=15 dimensions, or the number of catalogues such that they capture the largest part of the variance of the ratings.

2.3. Dimension Reduction (e)

Factor Analysis is a well-known dimensionality reduction technique: from v initial individual item dimensions, scores for f scores which capture as much variability of the original variables as possible are computed. Factor analysis has the additional benefit of allowing rotations, i.e., optimization of the f dimensions obtained, so that they have some properties. For computing IRT models a requirement is having uncorrelated dimensions, and this is possible using an orthogonal rotation (Gorsuch, 1983 [5]).

SAS PROC FACTOR was used to compute the Factor Analysis. Output of this procedure is a table or ordered items into the f (15) previously defined dimensions or catalogues. This is called the Rotated Factor

2.4 Storing the Catalogue Repositories and Computing Preference Measures on them (f)

Factor Analysis does not provide, by itself, an interpretation of the extracted dimensions. This is usually a manual process made by humans, after observing the factor solution. Though not part of the purpose of this invention, since it is intended to be fully automatic, and for illustration purposes a subjective interpretation for this particular set is presented:

| | |
|---|---|
| Factor 1 | “mainstream” or “blockbuster” films, composed of 34 |
| | entertainment movies for all kinds of people |
| Factor 2 | Humour films, not only comedy, but for younger people |
| Factor 3 | Children movies, mostly including animations |
| Factor 4 | Romantic comedy |
| Factor 5 | Drama, serious film |
| Factor 6 | Independent cinema |
| Factor 7 | Horror/Terror films |
| Factor 8 | Movies for teenagers |
| Factor 9 | Action Sci-Fi |
| Factor 10 | Mainstream, but more “intellectual” niche dimension |
| Factor 11 | Less popular sci-fi |
| Factor 12 | “Queer” niche sector |
| Factor 13 | Difficult to interpret and sparsely populated (1 single movie in |
| to 15 | one factor) |

2.5 Creating the IRT Models (g)

As an example PCM (an IRT model) for the Catalogue based on Factor 9 has been computed, and it contains the following list of movies with the following identifications: 2985, 3527, 589, 2916, 1200, 3703, 1587, 1261, 1129, and 1676.

| Movie_id | Number of raters | Movie year |
|---|---|---|
| 2985 | 7765 | 1987 |
| 3527 | 7527 | 1987 |
| 589 | 28948 | 1991 |
| 2916 | 11479 | 1990 |
| 1200 | 14167 | 1986 |
| 3703 | 4437 | 1981 |
| 1587 | 3503 | 1982 |
| 1261 | 3952 | 1987 |
| 1129 | 4860 | 1981 |
| 1676 | 8491 | 1997 |

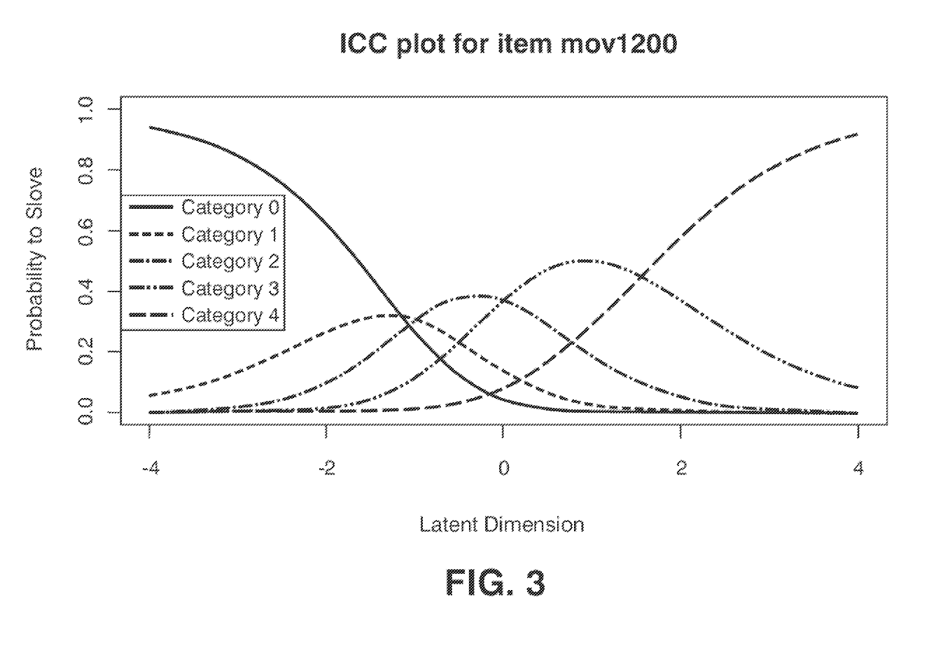

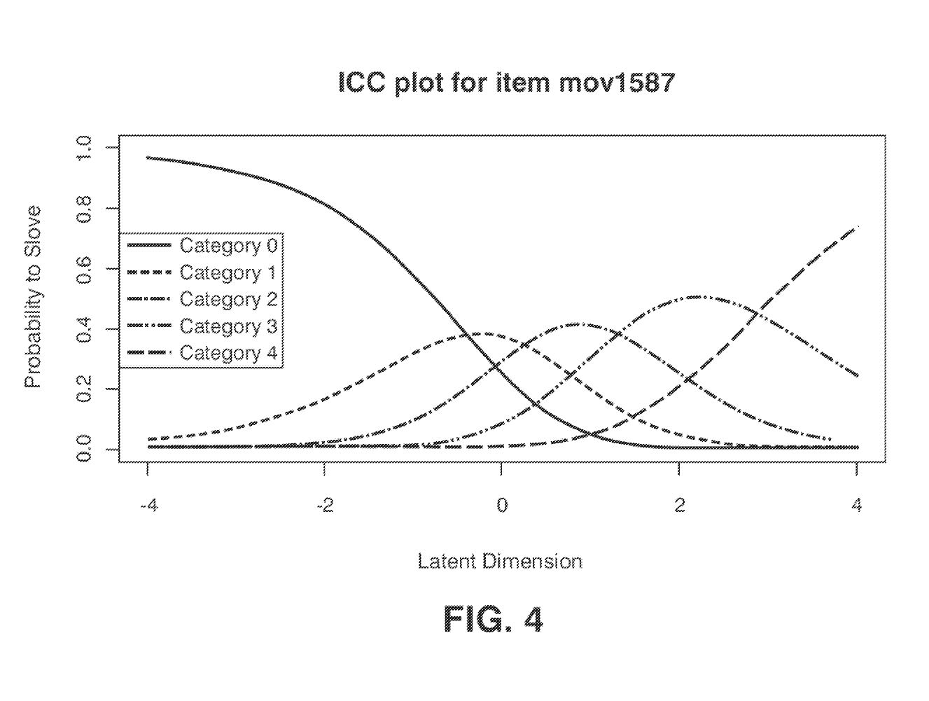

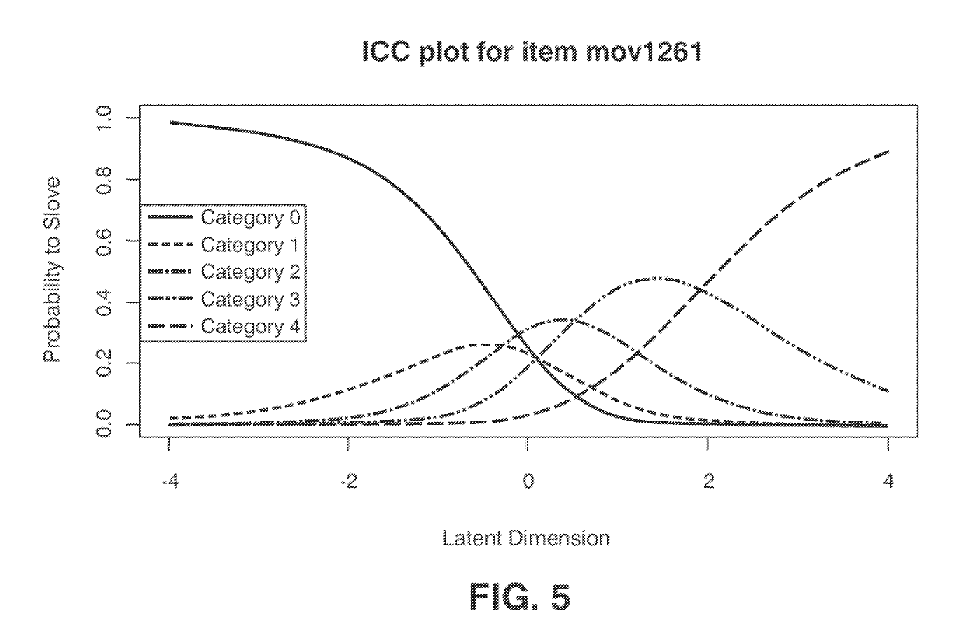

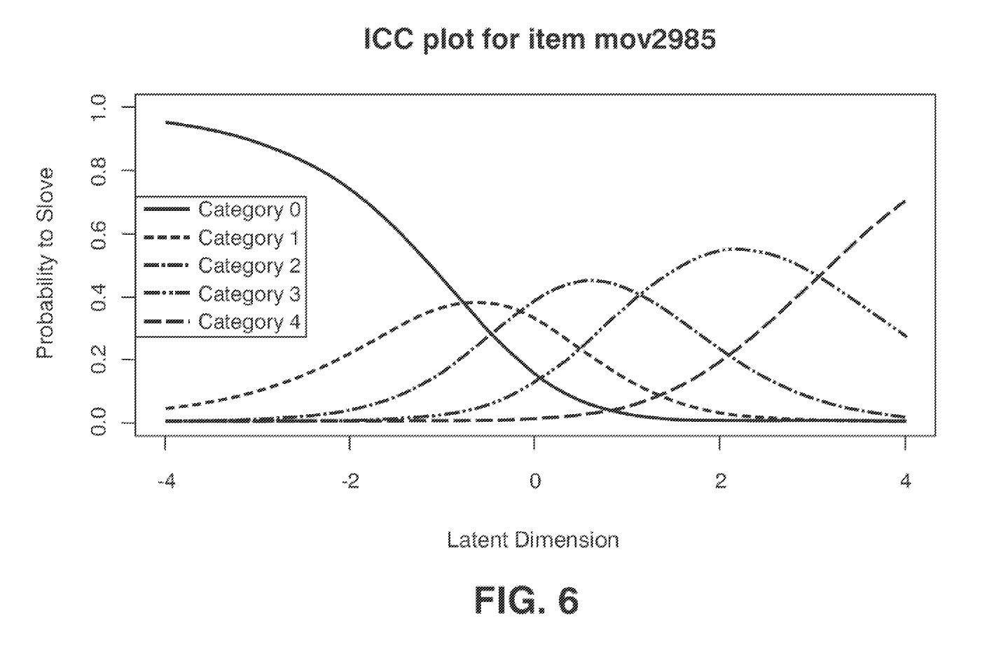

FIGS. 3 to 6 showed a few examples of the ICC (Item Characteristic Curves) that illustrate the resulting models obtained for certain items in this catalogue.

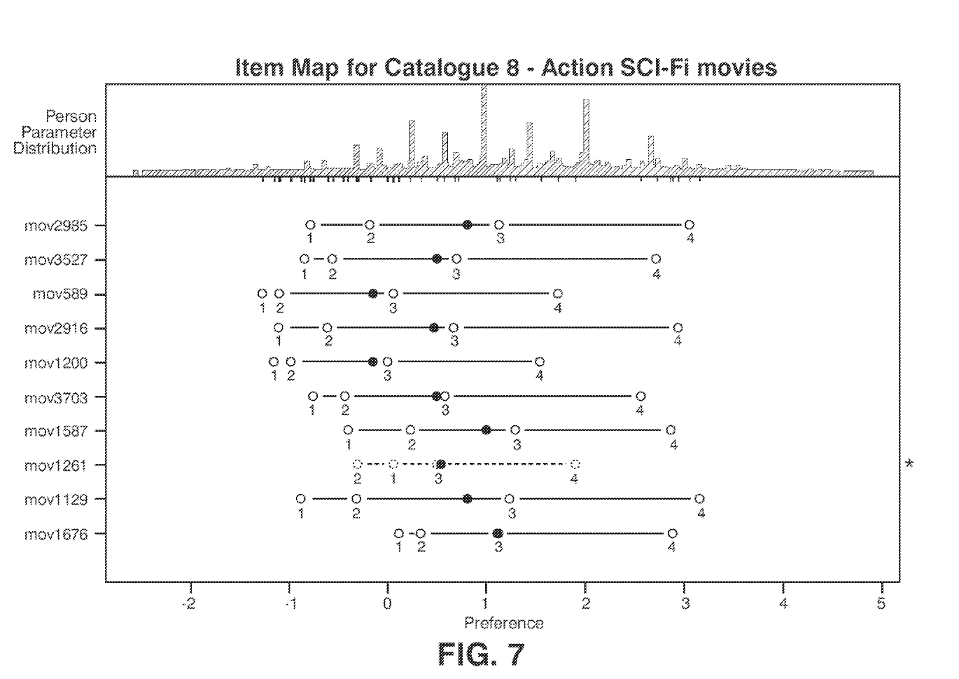

A useful plot is the Item Plot which depicts all items, which share the same scale, together with the distribution of preference measurements, as shown in FIG. 7. This allows detecting (and possibly deleting from the catalogue) items with strange behaviour (movie 1261 in this case, highlighted in the figure), but most important, they allow setting up a process to select the most relevant item for starting rating the catalogue for the adaptive process.

All these parameters are stored in the Catalogues Repository, that part of the system which makes these data available to the other modules of the system, and in particular, to the Adaptive Profiling Presentation and UI system.

A particular exploitation of this stored data would be its use in a recommendation system, which is beyond the scope of this patent proposal.

3. Example of a New User Profile Acquisition by Means of Adaptive Profiling Presentation and UI System (k)

In this example embodiment steps (i) and (j) are skipped, for the sake of simplicity, and also to show that they are optional steps: they provide useful functionality, but the overall system can also work without them.

The above computed Catalogue for Action Sci-Fi movies will be used in order to describe how this system works. A new user connects to this system in order to provide his preference profile towards this (and many other possible) catalogue(s).

In order to measure the preference towards the catalogue as quickly but as reliably as possible, it is convenient to choose as starter those items which position themselves towards the average preference within it. In this case, movies 3527, 2916 and 3703 are the closest ones to the average, so these are the candidates for starting the procedure.

For the following steps, let's consider three different example types of users in this process:

User Who Really Likes the Movies in this Catalogue.

This user is first presented movie 2916, and he rates it with 8 (in a scale of 1 to 10). This score indicates a high preference measurement, so he is then presented withStarship Troopers. He again rates this movie with 8, so the measurement process determines the measurement is done with enough reliability, and then the catalogue can be finished. The user always receives feedback about the measurement process for validating its output, and requests permission to leave this catalogue and proceed to the next one.

User Who does not Like Much the Movies in this Catalogue.

This user is presented movie 2916, and he rates it 3 (in scale 1 to 10 as before). In this case it is recommended to move in small steps around the average preference measure, so movie 3703 is presented next. A score of 5 is then provided. Since this response indicates a possible trend towards higher preference in this dimension or catalogue, he is then offered movie 1129, which is rated with 2. Next presented movie returns to the average, so movie 3527 is presented, with a rating of 3. The measurement process control determines the preference measure is reliable enough and stops the presentation.

As with the previous example user, feedback is provided and permission requested to proceed to other catalogues.

User with Inconsistent or Too-Variable Responses for this Catalogue.

As with previous users, he is presented first with movie 2916. A score of 5 (in a scale 1 to 10 as previously) is provided, so we proceed to the next potentially more preferred movie, movie 1129, but this movie is rated with 1. The management process returns to the average movies, and movie 3703 is presented next. This is rated 7, and then movie 1676 is presented next. But this is scored 1. The system determines it cannot provide a preference measurement within previously defined confidence limits. This is communicated to the user, stating that this catalogue can be again scored in future steps, but for the moment it cannot provide a reliable measurement.

Reasons for this behaviour can be many, among them, of course, that the user is not responding in a consistent way. But it can happen that the catalogue is not well defined, or that the user actually only likes a very reduced subset of it. In all cases, the procedure to reach to a stable measurement would be rather long and unreliable, so that the system has control points to detect and signal this circumstance.

### Advantages of the Invention

The following items summarize the most significant advantages of the proposed procedure:
The use of adaptive user profiling enables a faster acquisition of a profile than a traditional system: the number of items needing evaluation by the user is minimized individually for each user, instead of using a one-size-fits-all questionnaire
This in turn improves reliability of the procedure, since it reduces the burden on the users side and avoids her getting tired and randomly finishing up the questionnaire or leaving it incomplete.
The itemset rated by each user at profile acquisition is, in principle, different. This improves diversity of tests, avoids concentrating rating acquisition on always the same set of items and can achieve a better evolution of the item repository.
The use of IRT models achieves a better characterization of each individual item's response model than simple prior probabilities, which in turn is able to provide a more adequate procedure for selecting items for the adaptive profiling step.
The procedure is generic enough so that it is applicable to many different domains. In particular, factor analysis is semantically agnostic, so no determination of semantic categories to find a-priori item clusters (dimensions) is needed.
The use of different IRT models enables the use of the invention in context using different user input: binary decisions or integer-scale ratings will both work.
The fast and direct dynamic profiling process enabled by the APP opens up new possibilities for quick recommendation engines, in which a specially crafted environment (such as e.g. a kiosk) can provide recommendations very fast to new users.
As a particular case, it might facilitate a gift recommendation engine in which the user fills up a short and direct adaptive profile to uncover the preferences of the person to be given the gift, and the system then proceeds to provide recommendations specifically adapted to that on-the-fly profile. Thanks to the adaptive profiling process, this is done in minimum time and effort.

A person skilled in the art could introduce changes and modifications in the embodiments described without departing from the scope of the invention as it is defined in the attached claims.

### ACRONYMS

APS Adaptive Profiling Session
APSM Adaptive Profiling Session Management
CA Client Application
CAA Client-side Autonomous Application
CAT Computer Assisted Testing
ICC Item Characteristic Curves
ICR Item Characteristics Repository
IRT Item Response Theory
MDS Multidimensional Scaling
OPMS Online Profile Management System
PCA Principal Component Analysis
UPP User Preferences Profile

### REFERENCES

[1] Bonnefoy, D.; Bouzid, M.; Lhuillier, N.; Mercer, K. (2007): “More like this” or “Not for me”—Delivering Personalised Recommendations in Multi-User Environments. Proc. of 11th International Conference, UM2007, LNAI 4511, Springer Verlag, pp. 87-96.
[2] ChoiceStream technology brief. http://www.choicestream.com/pdf/cs_press_{—}030819_{—}1.pdf Retrieved Nov. 11, 2011.
[3] FilmAffinity.com—http://www.filmaffinity.com/en/tourphp?idtour=29. Retrieved Nov. 11, 2011
[4] Gibbons, Robert D. and Hedeker, Donald R. (1992): Full-information item bi-factor analysis. Psychometrika. Volume 57, Number 3, 423-436.
[5] Gorsuch, R. L. (1983). Factor Analysis, 2nd edition. Lawrence Erlbaum.
[6] Grouplens Research Group (2009): The Movielens recommendation system. http://www.movielens.org. Retrieved Nov. 11, 2011.
[7] Horn, J. L. (1965). A rationale and test for the number of factors in factor analysis. Psychometrika, 30, 179-185.
[8] Hurwitz, J. B. (2006): Empirical Evaluation of Content-Based Filtering for Personalization. 20th International Symposium on Human Factors in Telecommunication. Sophia-Antipolis, France, 20-23 Mar. 2006.
[9] Jameson, A. (2004): More than the sum of its members: Challenges for group recommender systems. Proceedings of the International Working Conference on Advanced Visual Interfaces, pp. 48-54.
[10] Lord, F. M.; Novick, M. R. (1968): Statistical theories of mental test scores. Reading, Mass.: Addison-Wesley.
[11] Luce, R. D. (1977). “The choice axiom after twenty years”. Journal of Mathematical Psychology 15 (3).
[12] Masters, G. N. (1982). A Rasch model for partial credit scoring. Psychometrika, 47, 149-174.
[13] O'Connor, B. P. (2000). SPSS and SAS programs for determining the number of components using parallel analysis and Velicer's MAP test. Behavior Research methods, instruments & Computers, 32(3), 396-402.
[14] Raiche, G. and Magis, D. (2010). Package ‘nFactors’. Parallel Analysis and Non Graphical Solutions to the Cattell Scree Test. Available at CRAN repository: http://cran.r-project.org/web/packages/nFactors/nFactors.pdf
[15] Rasch, G. (1980). Probabilistic models for some intelligence and attainment tests. Chicago: The University of Chicago Press.
[16] Ribière, M. (1999): Representation et gestion de multiples points de vue dans le formalisme des graphes conceptuels. PhD thesis, University of Nice, France.
[17] Smyth, B. & Cotter P. (2001): Personalized Electronic Program Guides for Digital TV, AI Magazine, Volume 22, N. 2, pp 89-98
[18] Thompson, N. A. (2007): A Practitioner's guide for variable-length computerized classification testing. Practical Assessment, Research & Evaluation. Vol. 12, No. 1, January 2007.

1. A computer-implemented method to manage user profiles regarding user preferences towards a content, said content being previously rated by a group of users via computing devices, the method comprising generating adaptive catalogues for a user by means of Item Response Theory models applied to at least part of said content and generating a user profile for said user by at least presenting items of said adaptive catalogues to said user, through a user computing device, and analysing scores given by said user to said items via said user computing device.

2. A computer-implemented method as per claim 1, comprising storing said content previously rated by said group of users in a computationally tractable form content in a ratings database, said computationally tractable form content at least containing the following information per user: items of said content rated by a given user and ratings given to said items by said given user, wherein said ratings can be binary, continuous or integer.

3. A computer-implemented method as per claim 2, comprising generating a matrix from at least part of said content stored in said tractable form content by selecting items of said content according to a specific criteria, wherein one dimension of said matrix corresponds to users and other dimension of said matrix corresponds to items and each position of said matrix corresponds to a rating given to a concrete item by a concrete user.

4. A computer-implemented method as per claim 3, wherein said specific criteria consists in selecting items that contain the highest possible number of ratings or selecting items whose rating distribution is as expanded as possible.

5. A computer-implemented method as per claim 3, comprising applying dimension reduction techniques to said matrix in an iterative way or as a single forward process, said reduction techniques being one of the following non-closed list: Factor Analysis, Principal Component Analysis, Cluster Analysis, Multidimensional Scaling and Bifactor model.

6. A computer-implemented method as per claim 5, comprising determining a number of dimensions in order to apply said reduction techniques by applying rules over a set of factor decompositions of said matrix and comparing some components over said set of factor decompositions to find an appropriate number of dimensions.

7. A computer-implemented method as per claim 6, wherein said components are eigenvalues obtained from said set of factor decompositions.

8. A computer-implemented method as per claim 7, comprising establishing said number of dimensions by determining, for each factor decomposition of said set of factor descompositions, an error generated by representing each item only with significant components and selecting the factor decomposition that produces a target overall statistical error, said significant components being determined according to a comparison performed between relative sizes of said eigenvalues.

9. A computer-implemented method as per claim 6, comprising creating item banks in order to store at least part of items of said content, wherein the number of item banks is determined by said number of dimensions.

10. A computer-implemented method as per claim 9, comprising:
assigning a set of weights to each item of said content, said set of weights indicating a degree of assignment of a given item to each of said item banks and being obtained by using one technique of the following non-closed list: Principal Component Analysis, Factor Analysis, Multidimensional Scaling or Bifactor models; and
classifying an item of said content into a corresponding item bank by determining its dominant factor according to said set of weights assignment.

11. A computer-implemented method as per claim 10, comprising determining said dominant factor by applying a thresholding technique for which only one weight of the set of weights of said item is above a threshold, said one weight referred to said corresponding bank.

12. A computer-implemented method as per claim 10, comprising storing said item banks in a database, wherein said item banks contain items assigned according to said classification and ratings associated to said items.

13. A computer-implemented method as per claim 12, comprising ordering items of said item banks by applying said Item Response Theory models to each element of said item banks giving as a result an Item Characteristic Repository containing said item banks and computed model parameters for each of said items, each of said computed model parameters establishing a ranking to order said items.

14. A computer-implemented method as per claim 2, comprising generating a start-up profile for a new user, said start-up profile containing socio-demographic information of said new user, said socio-demographic information being requested to said new user via an online form or questionnaire or being collected by accessing to a customer database.

15. A computer-implement method as per claim 13, comprising generating a start-up profile for a new user, said start-up profile containing socio-demographic information of said new user, said socio-demographic information being requested to said new user via an online form or questionnaire or being collected by accessing to a customer database, presenting to said new user groups of items of said Item Characteristic Repository in order to perform, said new user, an evaluation over each item of said groups items, each of said groups of items constituting an adaptive catalogue and having as many groups of items as item banks stored in said Item Characteristic Repository.

16. A computer-implemented method as per claim 15, comprising choosing, said new user, the order in which said adaptive catalogues are presented or presenting automatically said adaptive catalogues to said new user following an order.

17. A computer-implemented method as per claim 16, wherein said order is determined by decreasing item population, being answered first those adaptive catalogues that have been answered more by previous users, or wherein said order is determined by presenting first those adaptive catalogues which contain less items.

18. A computer-implemented method as per claim 16, comprising and performing the following iterative process once that said new user has rated a first item of a concrete adaptive catalogue:
selecting an item of said Item Characteristic Repository of said concrete adaptive catalogue and presenting it to said new user, said item being selected in terms of discrimination power for a preference of said new user in said concrete adaptive catalogue, and said discrimination power being computed in an adaptive manner by looking at a residual preference uncertainty remaining after processing all preceding ratings added by said user on items from said concrete adaptive catalogue;
rating, said new user, said selected item;
computing a user score for said concrete adaptive catalogue and a confidence interval using said rating, and at least one computed model parameter stored for said selected item in said Item Characteristic Repository;
checking if said confidence interval for said concrete adaptive catalogue is within a residual preference uncertainty threshold previously defined in order to establish the last iteration; and
storing said rating in said ratings database.

19. A computer-implement method as per claim 18, comprising defining a user profile for said new user according to user scores obtained for each adaptive catalogue after performing said iterative process.

20. A system to manage user profiles regarding user preferences towards a content, said content being previously rated by a group of users via computing devices, the system comprising:
a first server which at least stores items and ratings associated thereto from said content, and computes at least part of said items and ratings;
an Item Characteristic Repository which stores said items and ratings in the form of item banks; and
a session management module which creates adaptive catalogues with items from said Characteristic Repository and computes scores given to said items of said adaptive catalogues by a user connected to said session management module via a user computing device in order to provide a user profile for said user.

21. A system as per claim 20, wherein said adaptive catalogues change from one to user to another according to Item Response Theory models applied to at least part of said content in said first server and to scores provided by users to said session management module.

22. A system as per claim 21, wherein said adaptive catalogues are presented to said user through a client application running in said user computing device and said scores are provided to said session management module trough said client application.

23. A system as per claim 21, wherein it comprises an online profile management module which stores said user profile in the form of quantification of user preferences in a series of latent dimensions spanned by said items.

24. A system as per claim 20, where the system generates a start-up profile for a new user, said start-up profile containing socio-demographic information of said new user, said socio-demographic information being requested to said new user via an online form or questionnaire or being collected by accessing to a customer database.
